(19) United States
(12) Patent Application Publication
(10) Pub. No.: US 2023/0271041 A1
(43) Pub. Date: Aug. 31, 2023

(54) Spray Module and Device Method For Fighting a Vegetation Fire

(71) Applicant: HOZE SOLUTIONS GMBH, Bergisch Gladbach (DE)

(72) Inventors: Martin Peter Hofmann, Zurich (CH); David Johannes Reinhard Zenz, Bergisch Gladbach (DE)

(21) Appl. No.: 18/016,082

(22) PCT Filed: Jul. 20, 2021
(86) PCT No.: PCT/EP2021/070270

§ 371 Date: Jan. 13, 2023

(30) Foreign Application Priority Data
Jul. 27, 2020 (DE) 10 2020 119 754.3

(51) Int. Cl. A62C 3/02; A62C 31/00

(52) U.S. Cl. CPC A62C 3/02; A62C 31/005

(57) ABSTRACT

A spray module for a device for fighting a vegetation fire, the spray module includes: an inlet for a fluid, an outlet for the fluid, a fastening unit for fastening the spray module in a raised position with respect to an underlying surface, a first spray mist nozzle having a first opening area, which is configured to dispense a first spray mist, and a second spray mist nozzle having a second opening area, which is configured to dispense a second spray mist, the first opening area and the second opening area are arranged parallel to one another on the spray module in such a way that the first spray mist and the second spray mist can be dispensed in two opposite directions.

### CROSS REFERENCE TO RELATED APPLICATIONS

This application is a US National Stage Entry of PCT/EP2021/070270 filed on Jul. 20, 2021 and which claims the benefit of DE 10 2020 119 754.3 filed on Jul. 27, 2020, all of which are hereby incorporated by reference herein for all purposes.

### FIELD

The present invention relates to a spray module for a device for fighting a vegetation fire. The invention furthermore relates to a device for fighting a vegetation fire. Furthermore, the invention relates to a method for fighting a vegetation fire.

### BACKGROUND

Depending on the area, vegetation fires are often referred to as bush fires, field fires or forest fires and count as natural and environmental disasters. Fighting such fires is associated with great dangers for the emergency personnel and the materiel used, owing to a shortage of water and/or personnel and often difficult-to-access terrain. The unrestricted spread of such a vegetation fire also endangers human and animal habitats and can lead to life-threatening situations. In addition, critical infrastructure, such as power supply lines, power generation facilities or substations, is often affected.

Vulnerable areas are typically exposed to a warm climate, often with hot and dry winds, leading overall to dried out vegetation that can catch fire relatively easily. The spread of the fire can take place by convection, that is to say by contact between combustible material and burning material, or by heat radiation. Often strong winds also promote rapid spreading of vegetation fires.

To fight such a vegetation fire, the practice of producing moist zones in the vegetation is known in the prior art from FR 2 603 812 A. For this purpose, use is made of a system having a plurality of nozzles which are connected via conduits and are deployed in the vegetation threatened by a vegetation fire in order to moisten it. The nozzles are attached to the underlying surface of the terrain and are directed upward. During operation of the system, the nozzles each produce water fountains with a height of more than 5 m. Due to the discharge of the water as at least 5 m high water fountains, it may happen that the water is mainly absorbed in the air and only a small proportion of the discharged water contributes to moistening the vegetation. In particular, the vegetation in the immediate vicinity of the nozzle cannot be sufficiently moistened, and therefore there is a risk of damage to the nozzle and/or the conduit connected to the nozzle due to the vegetation fire. The probability of curbing the vegetation fire is therefore reduced.

DE 694 02 099 T2 describes a system for producing a spray bell consisting of droplets which can be used for fighting forest fires. The system comprises a plurality of atomizer posts, which are set up at a predetermined distance from one another. Each of the atomizer posts has a T-piece, which rests on the underlying surface and has two opposite openings, to which hoses for the supply of water can be connected. Arranged on the upper side of the T-piece is a rigid tube, at the upper end of which a single diffuser for producing droplets is provided. Fastening the entire atomizer post in a raised position with respect to the underlying surface is neither envisaged nor practicable. The atomizer post is held by one or more supporting feet, depending on height. Furthermore, the connection between the T-pieces of different atomizer posts is established by means of a further rigid tube, which cannot be adapted to local requirements.

DE 20 2020 103 781 U1 describes a device for distributing liquid during firefighting, having a stand for arranging the device on an underlying surface and an inlet pipe running vertically upward from the stand. The lower end of the inlet pipe has a T-piece for connecting two fire hoses. Arranged at the upper end of the inlet pipe is a single spray nozzle, which can be rotated about a vertical axis. This device too cannot be arranged as a whole in a position in which it is raised with respect to the underlying surface.

DE 693 19 915 T2 describes a spray head for a fire fighting device, having exactly one inlet for liquid and three nozzles arranged obliquely with respect to one another and with respect to the inlet.

### SUMMARY

It is the object of the present invention to increase the probability of curbing a vegetation fire.

To achieve the object, a spray module for a device for fighting a vegetation fire is proposed, wherein the spray module comprises:
an inlet for a fluid and
an outlet for the fluid and
a fastening unit for fastening the spray module in a raised position with respect to an underlying surface,
a first spray mist nozzle having a first opening area, which is designed to dispense a first spray mist, and
a second spray mist nozzle having a second opening area, which is designed to dispense a second spray mist, wherein the first and the second opening area are arranged parallel to one another on the spray module in such a way that the first spray mist and the second spray mist can be dispensed in two opposite directions.

The spray module according to the invention comprises both an inlet and an outlet for a fluid, so that the fluid can flow through the inlet into the spray module and a proportion of the fluid which is not dispensed to the environment by one of the spray mist nozzles can be passed on through the outlet of the spray module, for example to a further spray module. In this case, the fastening unit is designed to fasten the spray module in a raised position with respect to the underlying surface, thus enabling the position of the spray mist nozzles to be adapted to the height of the vegetation. The spray mist nozzles are arranged on the spray module in such a way that the spray mist dispensed by these spray mist nozzles can be dispensed in two opposite directions. By means of the spray module according to the invention, it is possible, from a raised position with respect to the underlying surface, to produce a spray mist, in particular a lobe-shaped spray mist, in two directions starting from the spray module. Improved moistening of the vegetation in the direct vicinity of the spray module can thereby be made possible. This opens up the possibility of producing a spray mist line parallel to a front of the vegetation fire. Moreover, the spray module can be better protected in this way against damage by the approaching fire. Overall, the result is an increased probability of stopping the vegetation fire.

According to one advantageous embodiment of the invention, the first spray mist nozzle is a flat jet nozzle and/or the second spray mist nozzle is a flat jet nozzle. Flat jet nozzles are also referred to as fan nozzles and can produce a fan-shaped spray pattern. With such an embodiment of the spray module, the first spray mist nozzle and/or the second spray mist nozzle can each produce a fan-shaped spray mist.

One advantageous embodiment of the invention envisages that the first spray mist nozzle is arranged on a first side of the spray module and the second spray mist nozzle is arranged on a second side of the spray module, which is opposite the first side. By means of such an arrangement of the spray mist nozzles, a compact construction of the spray module can be made possible, wherein a pressure chamber is arranged, in particular, between the first and the second spray mist nozzle, via which pressure chamber the fluid to be dispensed via the two spray mist nozzles is conveyed to the spray mist nozzles.

A preferred embodiment of the invention envisages that the spray module has a self-protection nozzle having a third opening area, which is designed to dispense a third spray mist, wherein the third opening area is arranged perpendicularly to the first and second opening areas. The spray module equipped with the self-protection nozzle can be aligned in such a way during use that the fluid is dispensed through the first and the second spray mist nozzle substantially in a direction parallel to a fire front, and the fluid can be dispensed toward the fire front via the self-protection nozzle substantially in a direction perpendicular to the fire front. Thus, the spray mist produced by the two spray mist nozzles can form a line parallel to the fire front, and the self-protection nozzle can moisten a region between the fire front and the spray module in order to reduce the risk posed to the spray module by the fire front. Provision is preferably made for the self-protection nozzle to be arranged on a third side of the main body, which is arranged substantially perpendicularly to the first side and perpendicularly to the second side. This arrangement permits a particularly compact embodiment of the spray module with a common pressure chamber between the two spray mist nozzles, from which the self-protection nozzle is also fed with the fluid. The self-protection nozzle can be designed as a nozzle with a round cross-sectional opening or as a flat jet nozzle.

According to one advantageous embodiment, it is envisaged that the inlet and the outlet are arranged coaxially with respect to a virtual fluid axis, and the third opening area of the self-protection nozzle is arranged parallel to the virtual fluid axis. The inlet and the outlet can be used to define a virtual fluid axis of the spray module, along which substantially the flow of the fluid from the inlet to the outlet takes place. The virtual fluid axis can be arranged so as to run in a direction perpendicular to the fire front. If a plurality of spray modules are connected to one another, the fluid can be guided along the virtual fluid axis parallel to the fire front from a first spray module to an adjacent, second spray module.

Provision is preferably made for the first opening area and the second opening area to be arranged parallel to an inlet opening area of the inlet and/or to an outlet opening area of the outlet. In such an embodiment, the fluid can be dispensed via the first spray mist nozzle in a first direction, which runs counter to the direction in which the fluid flows into the spray module. Furthermore, the fluid can be dispensed via the second spray mist nozzle in a second direction, which corresponds to the direction in which the fluid leaves the spray module through the outlet.

According to one advantageous embodiment, it is envisaged that the fastening unit is arranged on a side of the spray module which is opposite the self-protection nozzle. Such an arrangement of the fastening unit on the spray module has the advantage that the fastening unit can be arranged on a side of the spray module which faces away from the approaching fire front. The risk of the fastening unit being damaged by the fire front, or of an element interacting with the fastening unit, in particular part of the vegetation or a holder, being affected by the fire front, can therefore be reduced. Furthermore, assembly of the spray module in the suspended state can be made possible by means of the fastening unit. The fastening unit is preferably arranged on the spray module at the same height as the first and/or the second spray mist nozzle. Alternatively, the fastening unit may not be arranged on the spray module at the same height as the first and/or the second spray mist nozzle, being arranged lower or higher, for example.

The inlet and the outlet are preferably provided in an outer wall of a pressure chamber. According to one advantageous embodiment, the fastening unit is arranged on the outer side of the pressure chamber.

The pressure chamber is preferably arranged in or on a housing of the spray module, wherein the housing has the inlet and the outlet and the first spray mist nozzle and the second spray mist nozzle and, if appropriate, the self-protection nozzle. As a particular preference, the fastening unit is arranged on an outer side of the housing. The housing can be designed as a split housing having two housing parts, wherein a first housing part has the inlet and the outlet, and a second housing part has the first spray mist nozzle and the second spray mist nozzle and, if appropriate, the self-protection nozzle. Alternatively, the housing can have a housing part which has the inlet and the outlet and the first spray mist nozzle and the second spray mist nozzle and, if appropriate, the self-protection nozzle. In particular, the housing can be designed as a one-piece housing which has the inlet and the outlet and the first spray mist nozzle and the second spray mist nozzle and, if appropriate, the self-protection nozzle. The fastening unit is preferably provided on an outer side of the first housing part.

One advantageous embodiment envisages that the fastening unit comprises a tubular region for connection to a rod-shaped element and/or a flange region. The flange region preferably has a plurality of through holes, through which a fastening element can be passed. By means of the fastening element, the flange region can be fastened on an element of the vegetation. A cable, a wire or a cable tie, for example, can be used as the fastening element.

According to one advantageous embodiment, it is envisaged that the inlet and the outlet define a maximum longitudinal extent of the spray module, and the spray module has a vertical extent arranged perpendicularly to the longitudinal extent and a transverse extent arranged perpendicularly to the longitudinal extent and to the vertical extent, wherein a ratio of the vertical extent to the longitudinal extent is in the range of from 1 to 3, preferably in the range of from 1 to 2, and/or wherein a ratio of the transverse extent to the longitudinal extent is in the range of from 1 to 3, preferably in the range of from 1 to 2. Such an embodiment allows a particularly compact construction of the spray module.

According to one advantageous embodiment, the spray module has a weight in the range of from 10 g to 5000 g, preferably in the range of from 25 g to 1000 g, for example in the range of from 40 g to 700 g.

One advantageous embodiment of the invention envisages that the first opening area has a size of from 0.05 mm² to 5 mm². The first opening area preferably has a size of from 0.05 mm² to 0.15 mm² or from 0.15 mm² to 0.5 mm² or from 0.5 mm² to 1.5 mm² or from 1.5 mm² to 2.5 mm² or from 2.5 mm² to 5 mm². An opening area in one of the specified ranges has proven to be particularly effective for producing a spray mist by means of which the adjacent vegetation can be moistened.

One advantageous embodiment of the invention envisages that the second opening area has a size of from 0.05 mm² to 5 mm². The second opening area preferably has a size of from 0.05 mm² to 0.15 mm² or from 0.15 mm² to 0.5 mm² or from 0.5 mm² to 1.5 mm² or from 1.5 mm² to 2.5 mm² or from 2.5 mm² to 5 mm². An opening area in one of the specified ranges has proven to be particularly effective for producing a spray mist by means of which the adjacent vegetation can be moistened.

As a particular preference, the first and the second opening area have an identical size, enabling the fluid to be dispensed symmetrically from the spray module.

One advantageous embodiment of the invention envisages that the third opening area has a size of from 0.05 mm² to 2.5 mm². The third opening area preferably has a size of from 0.05 mm² to 0.15 mm² or from 0.15 mm² to 0.5 mm² or from 0.5 mm² to 1.5 mm² or from 1.5 mm² to 2.5 mm². An opening area in one of the specified ranges has proven to be particularly effective for producing a spray mist by means of which the adjacent vegetation can be moistened.

One advantageous embodiment envisages that the inlet has an inlet connection and/or the outlet has an outlet connection. Via the inlet connection and/or the outlet connection, a respective connecting element, which comprises a connector, can be connected to the spray module. Thus, the spray module can connect two conduits. Here, the spray module fulfills a dual function as a dispensing device for a first part of the fluid and as a connecting piece for the passage of a second part of the fluid. The inlet connection and/or the outlet connection can have a latching element or a latching contour in which a connecting piece of a conduit can latch. Alternatively, the inlet connection and/or the outlet connection can have a thread.

To achieve the object mentioned at the outset, a device for fighting a vegetation fire is furthermore proposed, having a first fire fighting line having at least a first and a second spray module as described above and a first conduit for the fluid, wherein the first and the second spray module are connected via the first conduit for the fluid.

In the device for fighting a vegetation fire, the same advantages can be achieved as have been described above in connection with the spray module. In this case, the first conduit connects two, in particular identically designed, spray modules for the formation of a fire fighting line. The fire fighting line allows the vegetation to be moistened along a line, in particular parallel to a fire front. The line can be straight or curved.

An embodiment in which a distance between the first and the second spray module is in the range of from 2 m to 10 m, preferably in the range of from 3 m to 5 m, for example 4 m, has proven advantageous. Such a distance permits uniform moistening of the vegetation along the line defined by the fire fighting line in the vegetation.

According to one advantageous embodiment, it is envisaged that the opening areas of the first and second spray mist nozzles of the first and second spray modules are aligned in parallel in order to produce mutually overlapping spray mists. Such an embodiment offers the possibility of forming a continuous, linear spray mist region. This spray mist region can bring about linear moistening of the vegetation.

A preferred embodiment of the device comprises a second fire fighting line having at least a third and a fourth spray module as described above and a second conduit for the fluid, wherein the third and the fourth spray module are connected via the second conduit, wherein the second fire fighting line is arranged parallel to the first fire fighting line. By such an arrangement of the spray mist modules in two parallel fire fighting lines, the intensity of moistening can be increased and/or the moistened region of the vegetation can be increased. If the first and the second fire fighting line are arranged parallel to one another at the same height with respect to the underlying surface, a two-stage defense can be formed in relation to the fire front.

The first and the second fire fighting line are preferably arranged at a different height from an underlying surface, making it possible to produce a spray mist wall which allows moistening of the vegetation at several heights relative to the underlying surface. The first, second, third and fourth spray mist modules are preferably of identical design.

The first and the second fire fighting line are preferably fluidically connected to one another, thus enabling the fluid to be passed first through the first fire fighting line and then through the second fire fighting line or vice versa. Alternatively, the first and the second fire fighting line can be separated from one another in such a way that a fluid is passed from a first source into the first fire fighting line and a fluid is passed from a second source into the second fire fighting line.

One advantageous embodiment envisages that the first and the second spray module of the first fire fighting line are arranged offset with respect to the third and fourth spray modules of the second fire fighting line. By means of such an arrangement, more uniform moistening of the vegetation in the vicinity of the first and second fire fighting lines can be made possible. Such a configuration has proven to be advantageous particularly in those applications in which the first and the second fire fighting line are arranged at a different height with respect to an underlying surface.

The invention furthermore relates to the use of one or more of the above-described spray modules for fighting a vegetation fire.

The object mentioned at the outset is furthermore achieved by a method for fighting a vegetation fire, wherein the vegetation has at least a first vegetation component with a maximum height of growth above an underlying surface in the range of from 0.5 m to 10 m, wherein
an at least a first spray module is provided, wherein the spray module comprises:
   an inlet for a fluid and
   an outlet for the fluid and
   a fastening unit for fastening the spray module in a raised position with respect to an underlying surface,
   a first spray mist nozzle having a first opening area, which is designed to dispense a first spray mist, and
a second spray mist nozzle having a second opening area, which is designed to dispense a second spray mist, wherein the first and the second opening area are arranged parallel to one another on the spray module,
wherein the spray module is arranged by means of the fastening unit in a raised position relative to the underlying surface in a region of the first vegetation component with the maximum height of growth of 10 m, and
wherein the first spray mist and the second spray mist are dispensed in two opposite directions.

In the method for fighting a vegetation fire, the same advantages can be achieved as have been described above in connection with the spray module and the device for fighting a vegetation fire.

The first vegetation component consists of growth close to the underlying surface or ground. The vegetation can also have further vegetation components, e.g. tall trees which are larger than the maximum height of growth of the first vegetation component. In this case, the vegetation comprises at least a second vegetation component, the height of growth of which, in particular the average height of growth, is greater than 10 m. The second vegetation component can have, for example, a height of growth, in particular a height of growth, in the range of from 10 m to 15 m.

The raised position in which the spray module is arranged by means of the fastening unit is preferably 0.5 m to 10 m above the underlying surface, particularly preferably 1 m to 10 m above the underlying surface or 2 m to 10 m above the underlying surface or 5 m to 10 m above the underlying surface or 9 m to 10 m above the underlying surface.

According to one advantageous embodiment of the invention, the first spray mist nozzle is a flat jet nozzle and/or the second spray mist nozzle is a flat jet nozzle. With such an embodiment of the spray module, the first spray mist nozzle and/or the second spray mist nozzle can each produce a fan-shaped spray mist.

One advantageous embodiment of the method envisages that the spray module is arranged by means of the fastening unit
on an element of a second vegetation component, wherein the element is higher than the maximum height of growth of the first vegetation component, or
on a holding element which is fixed on the underlying surface, in particular a rod. The rod is preferably higher than the maximum height of growth of the first vegetation component. The arrangement of the spray modules on an element of the second vegetation component or on a rod makes it possible to fasten the spray module independently of the first vegetation component. If the first vegetation component has been destroyed by the vegetation fire in the region of the spray module, the spray module can nevertheless be held by the element of the second vegetation component or the rod.

According to one advantageous embodiment of the invention, it is envisaged that the spray module comprises a self-protection nozzle having a third opening area, wherein the third opening area is arranged perpendicularly to the first and second opening areas, and a third spray mist is dispensed by means of the self-protection nozzle in the direction of the vegetation fire, in particular in the direction of a fire front of the vegetation fire. The spray mist produced by the two spray mist nozzles can form a line parallel to the fire front, and the self-protection nozzle can moisten a region between the fire front and the spray module in order to reduce the risk posed to the spray module by the fire front. Provision is preferably made for the self-protection nozzle to be arranged on a third side of the main body, which is arranged substantially perpendicularly to the first side and perpendicularly to the second side. This arrangement permits a particularly compact embodiment of the spray module with a common pressure chamber between the two spray mist nozzles, from which the self-protection nozzle is also fed with the fluid. The self-protection nozzle can be designed as a nozzle with a round cross-sectional opening (conical nozzle) or as a flat jet nozzle.

One advantageous embodiment of the method according to the invention envisages that the first and/or the second spray mist nozzle of the spray module have/has a roll angle in the range of from −45° to +45°, preferably in the range of from −10° to +10°, for example 0°, and/or have/has a pitch angle in the range of from −45° to +45°, preferably in the range of from −10° to +10°, for example 0°, relative to the underlying surface. By selecting the orientation in this way, the spray mist can be discharged as parallel as possible to the underlying surface.

According to one advantageous embodiment, it is envisaged that a volume flow in the range of from 3 l/h to 50 l/h, preferably of from 10 l/h to 20 l/h, for example 15 l/h, is in each case dispensed via the first and the second spray mist nozzle of the first spray module, optionally additionally via a self-protection nozzle of the spray module.

According to one advantageous embodiment, it is envisaged that a volume flow in the range of from 3 l/h to 50 l/h, preferably of from 10 l/h to 20 l/h, for example 15 l/h, per spray module is in each case dispensed via the first and the second spray mist nozzle of the first spray module, optionally additionally via a self-protection nozzle of the spray module.

One preferred embodiment envisages that, in addition to the first spray module, a second spray module, in particular of identical design to the first spray module, is provided, and the first and second spray modules are connected to one another via a first conduit for a fluid in order to obtain a first fire fighting line.

As a particularly preferred option, it is envisaged that, in addition, a third and a fourth spray module, in particular of identical design to the first spray module, are provided, and the third and fourth spray modules are connected to one another via a second conduit for a fluid in order to obtain a second fire fighting line, wherein the second fire fighting line is arranged parallel to the first fire fighting line.

The second fire fighting line is preferably arranged parallel to the first fire fighting line at a different height with respect to an underlying surface, thus enabling a spray mist wall to be produced. As an alternative preference, it is envisaged that the second fire fighting line is arranged parallel to the first fire fighting line and at a different distance from the fire front of the vegetation fire, with the result that a staggered arrangement of two fire fighting lines is achieved.

Further details, features and advantages of the invention will be found in the drawings and in the following description of preferred embodiments with reference to the drawings. The drawings merely illustrate exemplary embodiments of the invention, which do not restrict the scope of protection.

### BRIEF DESCRIPTION OF THE FIGURES

FIG. 1 shows an exemplary embodiment of a spray module according to the invention in a perspective illustration with a connected conduit.

FIG. 2 shows the spray module according to FIG. 1 in a perspective illustration from a different angle.

FIG. 3 shows the spray module according to FIG. 1 in a perspective side view.

FIG. 4 shows the spray module according to FIG. 1 in a perspective view from below.

FIG. 5 shows the spray module according to FIG. 1 in a perspective plan view.

FIG. 6 shows a diagram intended to illustrate the fluid distribution in the vicinity of a spray module.

FIG. 7 shows a schematic sectional illustration of a device for fighting a vegetation fire according to a first exemplary embodiment of the invention, having a plurality of spray modules.

FIG. 8 shows a schematic plan view of a device for fighting a vegetation fire according to a second exemplary embodiment of the invention, having a plurality of spray modules.

### DETAILED DESCRIPTION

In the various figures, identical parts are always provided with the same reference signs and are therefore generally also referred to or mentioned only once.

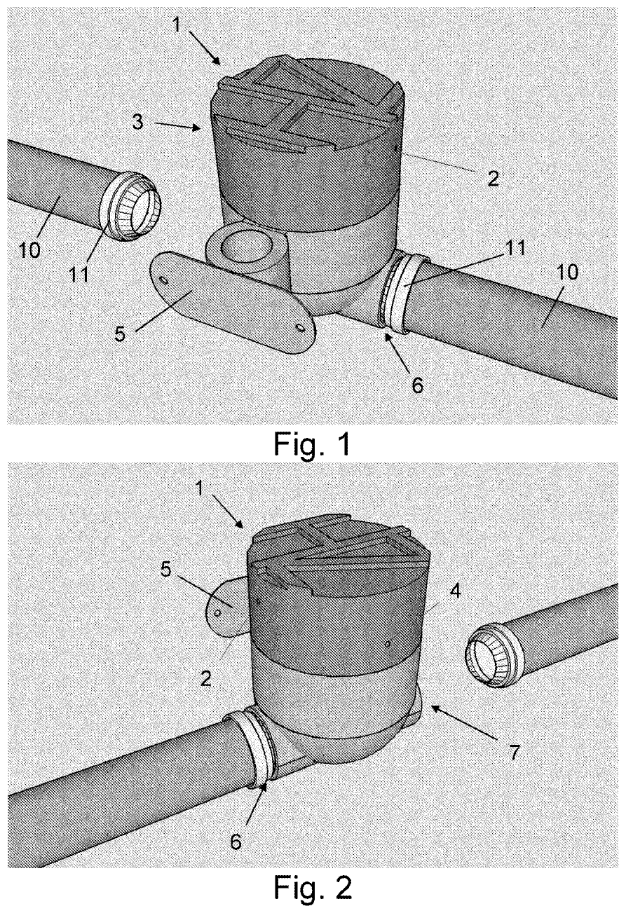

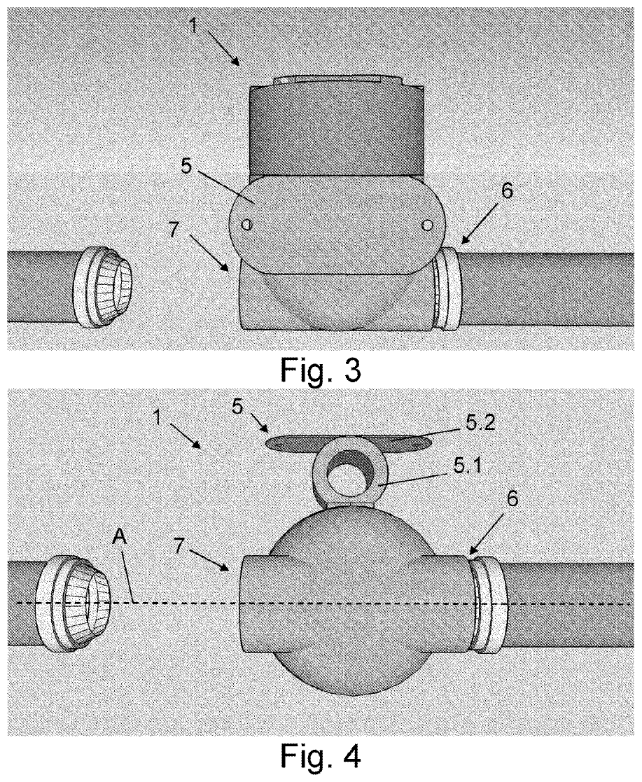

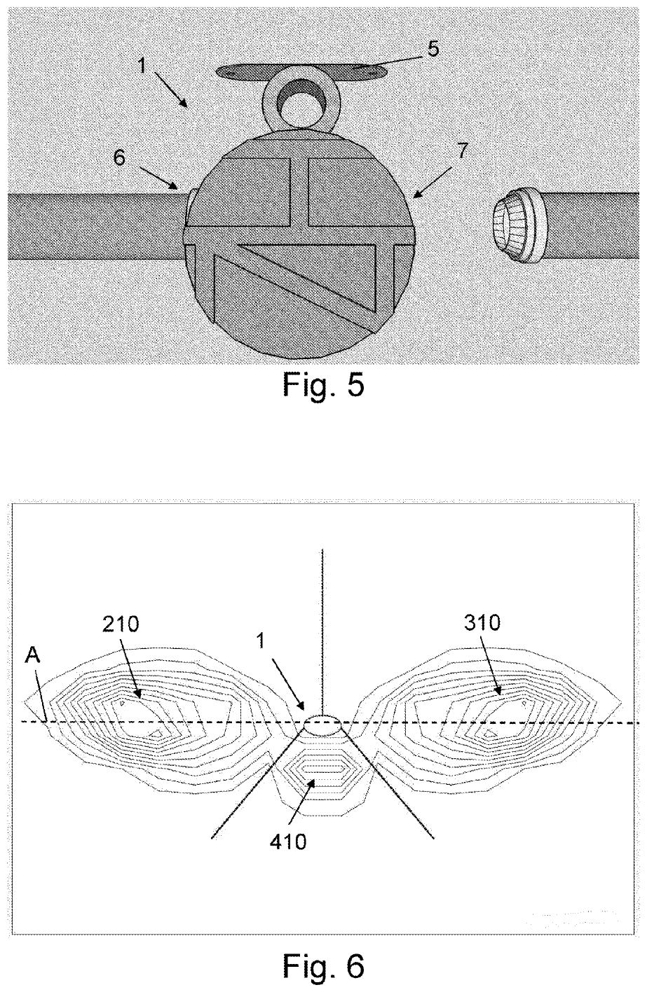

The illustrations in FIGS. 1 to 5 show an exemplary embodiment of a spray module 1 which is designed according to the invention and is suitable for use in a device for fighting a vegetation fire. The spray module 1 comprises an inlet 6 for a fluid and an outlet for the fluid 7. The inlet 6 and the outlet 7 are provided in the outer wall of a pressure chamber. Furthermore, the spray module 1 comprises a fastening unit 5 for fastening the spray module 1 in a raised position with respect to an underlying surface. In the exemplary embodiment, the fastening unit 5 is arranged on the outer side of the pressure chamber. The fastening unit comprises a tubular region 5.1 and a flange region 5.2. The tubular region 5.1 can be connected to a rod-shaped element, for example a bar, e.g. by the tubular region 5.1 being slipped onto the rod-shaped element. In the exemplary embodiment, the flange region 5.2 has a plurality of, in this case two, through holes, through which a fastening element can be passed in order to fasten the flange region 5.2 on an element of the vegetation. A cable, a wire or a cable tie, for example, can be used as the fastening element.

Furthermore, the spray module 1 has a first spray mist nozzle 2 having a first opening area, which is designed to dispense a first spray mist 210, and a second spray mist nozzle 3 having a second opening area, which is designed to dispense a second spray mist 310. The first and the second opening area are arranged parallel to one another on the spray module 1 in such a way that the first spray mist 210 and the second spray mist 310 can be dispensed in two opposite directions.

The first spray mist nozzle 2 is arranged on a first side of the spray module 1 and the second spray mist nozzle 3 is arranged on a second side of the spray module 1, which is opposite the first side. According to the exemplary embodiment, both the first spray mist nozzle 2 and the second spray mist nozzle 2 are designed as flat jet nozzles. Fan-shaped spray jets can be dispensed via these two spray mist nozzles 2, 3, each of which produces a flat spray 210, 310. Here, the first and the second opening area are of identical dimensions and have a size of 0.05 mm² to 5 mm².

The spray module 1 furthermore has a self-protection nozzle 4 having a third opening area, which is designed to dispense a third spray mist 410, wherein the third opening area is arranged perpendicularly to the first and second opening areas. The size of the third opening area is in a range of from 0.05 mm² to 2.5 mm². The self-protection nozzle 4 is arranged on a side of the spray module 1 which is opposite the fastening unit 5.

From the illustrations in FIGS. 1 to 5, it can be seen that the inlet 6 and the outlet 7 are arranged coaxially with respect to a virtual fluid axis A, and the third opening area of the self-protection nozzle 4 is arranged parallel to the virtual fluid axis A. The virtual fluid axis A essentially describes the direction of propagation of the fluid starting from the inlet 6 to the outlet 7 of the spray module 1. In this case, the virtual fluid axis A is arranged perpendicularly to an inlet opening area of the inlet 6 and to an outlet opening area of the outlet 7. The first opening area of the first spray mist nozzle 2 and the second opening area of the second spray mist nozzle 3, on the other hand, are arranged parallel to the inlet opening area of the inlet 6 and to the outlet opening area of the outlet 7.

The inlet 6 can have an inlet connection and the outlet 7 can have an outlet connection. In the exemplary embodiment, on the other hand, the inlet 6 and the outlet 7 each comprise a latching element or a latching contour, in which a connecting piece 11 of a conduit 10 can latch.

The illustrations in FIGS. 1 to 5 also show that the inlet 6 and the outlet 7 are provided in an outer wall of a pressure chamber. The fastening unit 5 is arranged on the outer side of the pressure chamber. The pressure chamber is arranged in a housing of the spray module 1, wherein the housing has the inlet 6 and the outlet 7 and the first spray mist nozzle 2 and the second spray mist nozzle 3 and the self-protection nozzle 4. The fastening unit 5 is arranged on an outer side of the housing. According to the exemplary embodiment, the housing is designed as a split housing having two housing parts, wherein a first, in this case lower, housing part has the inlet 6 and the outlet 7, and a second, in this case upper, housing part has the first spray mist nozzle 2 and the second spray mist nozzle 3 and the self-protection nozzle 4. The fastening unit 5 is provided on an outer side of the first housing part.

According to a modification of the exemplary embodiment shown in FIGS. 1 to 5, the housing has a housing part which has the inlet and the outlet and the first spray mist nozzle and the second spray mist nozzle and the self-protection nozzle. In particular, the housing can be designed as a one-piece housing which has the inlet and the outlet and the first spray mist nozzle and the second spray mist nozzle and the self-protection nozzle.

The diagram in FIG. 6 shows schematically, in a plan view, a distribution of a fluid dispensed by a spray module 1 according to the invention in the vicinity of the spray module 1. The first spray mist 210, which is dispensed via the first spray mist nozzle 2, extends on a first side of the spray module 1, and the second spray mist 310, which is dispensed via the second spray mist nozzle 3, extends on a second side of the spray module 1, which is opposite the first side. Thus, both the first and the second spray mist 210, 310 are distributed on both sides of the spray mist module 1 along the virtual fluid axis A. The third spray mist 410, which is dispensed via the self-protection nozzle 4, extends in a direction perpendicular to this virtual fluid axis A. When the spray module 1 is used to fight a vegetation fire, the self-protection nozzle 4 is aligned in the direction from which the approaching fire front of the vegetation fire is expected. In this case, the vegetation can be moistened by the first and the second spray mist nozzle 2, 3 along the virtual fluid axis and the vicinity, adjacent to the fire front, of the spray module 1 can be moistened by the self-protection nozzle 4.

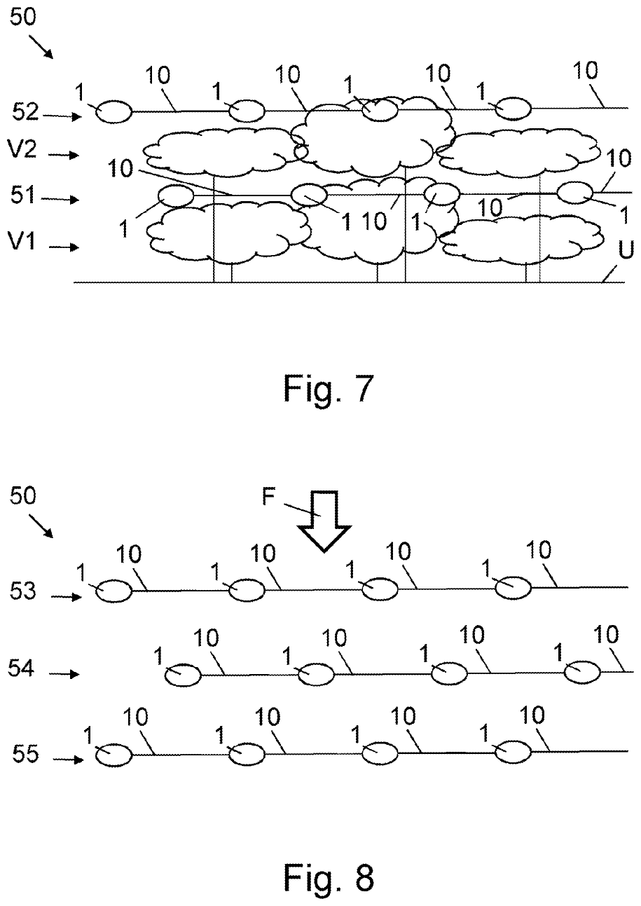

FIG. 7 shows a first exemplary embodiment of a device 50 for fighting a vegetation fire, which is designed according to the invention. The device 50 comprises a first fire fighting line 51 and a second fire fighting line 52, which each have a plurality of spray modules 1, which are designed as described above in conjunction with the illustrations in FIGS. 1 to 5. The spray modules 1 are each connected to one another via conduits 10, through which the fluid, for example water, can be passed. The fluid can be stored, for example, in a tank or a natural water source and can be delivered by a pump.

The illustration in FIG. 7 is a schematic sectional illustration. It is therefore possible to see different height levels in FIG. 7. The lowest level is formed by the underlying surface U. A first vegetation component V1 is present on this underlying surface. This first vegetation component V1 has a maximum height of growth above the underlying surface U which is in the range of from 0.5 m to 10 m, for example 8 m. The first vegetation component V1 can be formed, for example, by bushes and smaller trees. The first fire fighting line 51 having the plurality of spray modules 1 is arranged at a position raised with respect to the underlying surface, the height of the first fire fighting line 51, in particular of the spray modules 1 of the first fire fighting line 51, being less than the maximum height of growth of the first vegetation component V1. The first fire fighting line 51 is preferably arranged in a range of from 1 cm to 50 cm, preferably of from 1 cm to 30 cm, below the maximum height of growth of the first vegetation component V1.

According to the illustration in FIG. 7, the vegetation also has a second vegetation component V2, which comprises a maximum height of growth which is greater than the maximum height of growth of the first vegetation component V2. The first and the second vegetation component each have plants of different types, which differ, in particular, in their maximum height. Thus, the second vegetation component V2 comprises plants which typically grow higher than the plants contained in the first vegetation component. In the present case, the second vegetation component V2 has a maximum height of growth that is greater than 10 m, for example greater than 10 m but less than 30 m, or greater than 10 m but less than 20 m. The second vegetation component V2 can have a maximum height of growth of 15 m, for example.

The second fire fighting line 52 is arranged in the region of the second vegetation component V2, for example in a position which is in a range of from 1 cm to 50 cm, preferably of from 1 cm to 30 cm, below the maximum height of growth of the second vegetation component V2. The second fire fighting line 52 is arranged parallel to the first fire fighting line 51 at a different height with respect to the underlying surface U. Thus, the first and the second fire fighting line 51, 52 are at an identical distance from the fire front of the vegetation fire.

However, the two fire fighting lines 51, 52 are arranged with a mutual offset in such a way that the first and the second spray module 1 of the first fire fighting line 51 are arranged offset with respect to the third and fourth spray modules 1 of the second fire fighting line 52.

Optionally, further fire fighting lines may be present, which are not illustrated in FIG. 7 for reasons of clarity. The height of the first, second and, if appropriate, further fire fighting lines 51, 52 can be matched to the respective height of growth of the vegetation, in particular its vegetation components V1, V2. If further fire fighting lines are present, these are preferably likewise each arranged with an offset with respect to the respective adjacent fire fighting lines.

In the exemplary embodiment according to FIG. 7, the distance between the individual spray modules 1 is chosen to be in the range of from 2 m to 10 m, preferably in the range of from 3 m to 5 m, for example 4 m. The opening areas of the first and second spray mist nozzles 2, 3 of the spray modules 1 are aligned parallel, with the result that mutually overlapping spray mists 210, 310 are produced. This means that a first spray mist 310, which is produced by a first spray mist nozzle 2 of a first spray module 1, overlaps with a second spray mist 310, which is produced by the second spray mist nozzle 3 of a second spray module 1. The spray modules 1 are aligned in such a way that the self-protection nozzle 4 of the spray modules 1 can dispense a third spray mist 410 in the direction of a fire front of the vegetation fire. Furthermore, the spray modules are oriented in such a way that the first and/or the second spray mist nozzle 2, 3 of the spray module 1 have/has a roll angle in the range of from −45° to +45°, preferably in the range of from −10° to +10°, for example 0°, and/or have/has a pitch angle in the range of from −45° to +45°, preferably in the range of from −10° to +10°, for example 0°, relative to the underlying surface U.

The spray modules 1 of the first fire fighting line 51 are fastened by means of the respective fastening unit 5 of the spray module 1 either on an element of the second vegetation component V2, the element being higher than the maximum height of growth of the first vegetation component V1, or on a holding element which is fixed on the underlying surface U, in particular a rod.

During the operation of the device 50, a volume flow in the range of from 3 l/h to 50 l/h, preferably of from 10 l/h to 20 l/h, for example 15 l/h, is in each case dispensed via the first and the second spray mist nozzle 2, 3 and the self-protection nozzle 4 of each spray module 1.

FIG. 8 shows a second exemplary embodiment of a device 50 according to the invention for fighting a vegetation fire in a plan view. The device 50 comprises a first fire fighting line 53 as well as a second fire fighting line 54 and a third fire fighting line 55, which each have a plurality of spray modules 1, which are designed as described above in conjunction with the illustrations in FIGS. 1 to 5. The spray modules 1 are each connected to one another via conduits 10, through which the fluid, for example water, can be passed. The fluid can be stored, for example, in a tank or a natural water source and can be delivered by a pump.

The structure of the individual fire fighting lines 53, 54, 55 is identical to the structure of the fire fighting lines 51, 52 of the exemplary embodiment shown in FIG. 7, for which reason attention is drawn to the description of FIG. 7. In contrast to the exemplary embodiment according to FIG. 7, the fire fighting lines 53, 54, 55 are parallel to one another and are at different distances from a fire front of the vegetation fire. The vegetation fire propagates in a direction of propagation F, as indicated in FIG. 8. The fire fighting lines 53, 54, 55 are thus arranged one behind the other in a staggered manner, making it possible to moisten a larger vegetation area by means of the fire fighting lines 53, 54, 55 than would be the case with only one fire fighting line or a plurality of fire fighting lines arranged one above the other. Furthermore, the fire fighting lines 53, 54, 55 are arranged with a mutual offset in such a way that the first and the second spray module 1 of the first fire fighting line 53 are arranged offset with respect to the third and fourth spray modules 1 of the second fire fighting line 54. The third and fourth spray modules 1 of the second fire fighting line 54 are again arranged offset with respect to the spray modules 1 of the third fire fighting line 55.

### LIST OF REFERENCE SIGNS

1 spray module
2 spray mist nozzle
3 spray mist nozzle
4 self-protection nozzle
5 fastening unit
5.1 tubular region
5.2 flange region
6 inlet
7 outlet
10 conduit
11 connecting piece
50 device for fighting a vegetation fire
51 fire fighting line
52 fire fighting line
53 fire fighting line
54 fire fighting line
55 fire fighting line
210 spray mist
310 spray mist
410 spray mist
A virtual fluid axis
F direction of movement of the vegetation fire
U underlying surface

1. A spray module for a device for fighting a vegetation fire,
wherein the spray module comprises:
an inlet for a fluid,
an outlet for the fluid,
a fastening unit for fastening the spray module in a raised position with respect to an underlying surface,
a first spray mist nozzle having a first opening area, which is configured to dispense a first spray mist, and
a second spray mist nozzle having a second opening area, which is designed configured to dispense a second spray mist, wherein the first opening area and the second opening area are arranged parallel to one another on the spray module in such a way that the first spray mist and the second spray mist can be dispensed in two opposite directions.

2. The spray module as claimed in claim 1, wherein the first spray mist nozzle is a flat jet nozzle and/or the second spray mist nozzle is a flat jet nozzle.

3. The spray module as claimed in claim 1, wherein the first spray mist nozzle is arranged on a first side of the spray module and the second spray mist nozzle is arranged on a second side of the spray module, which is opposite the first side.

4. The spray module as claimed in claim 1, wherein the spray module comprises a self-protection nozzle having a third opening area, which is designed configured to dispense a third spray mist, wherein the third opening area is arranged perpendicularly to the first opening area and the second opening area.

5. The spray module as claimed in claim 4, wherein the inlet and the outlet are arranged coaxially with respect to a virtual fluid axis, and the third opening area of the self-protection nozzle is arranged parallel to the virtual fluid axis.

6. The spray module as claimed in claim 1, wherein the first opening area and the second opening area are arranged parallel to an inlet opening area of the inlet and/or to an outlet opening area of the outlet.

7. The spray module as claimed in claim 4, wherein the fastening unit is arranged on a side of the spray module which is opposite the self-protection nozzle.

8. The spray module as claimed in claim 1, wherein the inlet and the outlet are provided in an outer wall of a pressure chamber, and wherein the fastening unit is arranged on the outer side of the pressure chamber.

9. (canceled)

10. The spray module as claimed in claim 8, wherein the pressure chamber is arranged in a housing of the spray module, wherein the housing has the inlet and the outlet and the first spray mist nozzle and the second spray mist nozzle and optionally a self-protection nozzle.

11. The spray module as claimed in claim 10, wherein the housing is configured as a split housing having two housing parts, wherein a first housing part has the inlet and the outlet, and a second housing part has the first spray mist nozzle and the second spray mist nozzle and optionally the self-protection nozzle, wherein the fastening unit is provided on an outer side of the first housing part.

12. The spray module as claimed in claim 1, wherein the fastening unit comprises a tubular region for connection to a rod-shaped element.

13. The spray module as claimed in claim 1, wherein the fastening unit comprises a flange region, the flange region has a plurality of through holes, through which a fastening element can be passed.

14. (canceled)

15. (canceled)

16. (canceled)

17. (canceled)

18. The spray module as claimed in claim 1, wherein the inlet has an inlet connection and/or the outlet has an outlet connection, and wherein the inlet connection and/or the outlet connection has a latching element or a latching contour in which a connecting piece of a conduit can latch.

19. (canceled)

20. (canceled)

21. A device for fighting a vegetation fire, wherein the device comprises a first fire fighting line having a first and a second spray module each constructed according to the spray module as claimed in claim 1, and
wherein the device comprises a first conduit for the fluid, wherein the first and the second spray module are connected via the first conduit for the fluid.

22. (canceled)

23. The device as claimed in claim 21, wherein opening areas of the first spray mist nozzle and the second spray mist of the first and second spray modules are aligned in parallel in order to produce mutually overlapping spray mists.

24. The device as claimed in claim 21, wherein 21 to the device comprises a second fire fighting line having at least a third and a fourth spray module and a second conduit for the fluid, wherein the third and the fourth spray module are connected via the second conduit, wherein the second fire fighting line is arranged parallel to the first fire fighting line, and at a different height from an underlying surface.

25. The device as claimed in claim 21, wherein the first and the second spray module of the first fire fighting line are arranged offset with respect to the third and fourth spray modules of the second fire fighting line.

26. (canceled)

27. A method for fighting a vegetation fire, wherein the vegetation has at least a first vegetation component with a maximum height of growth above an underlying surface in the range of from 0.5 m to 10 m, wherein:
a first spray module is provided, wherein the first spray module comprises:
an inlet for a fluid,
an outlet for the fluid,
a fastening unit for fastening the first spray module in a raised position with respect to the underlying surface,
a first spray mist nozzle having a first opening area, which is configured to dispense a first spray mist, and
a second spray mist nozzle having a second opening area, which is configured to dispense a second spray mist, wherein the first opening area and the second opening area are arranged parallel to one another on the spray module,
wherein the first spray module is arranged by means of the fastening unit in a raised position relative to the underlying surface in a region of the first vegetation component with the maximum height of growth of 10 m, and
wherein the first spray mist and the second spray mist are dispensed in two opposite directions.

28. (canceled)

29. The method as claimed in claim 27, wherein the first spray module comprises a self-protection nozzle having a third opening area, wherein the third opening area is arranged perpendicularly to the first opening area and the second opening area, and a third spray mist is dispensed by means of the self-protection nozzle in a direction of the vegetation fire or in a direction of a fire front of the vegetation fire.

30. (canceled)

31. (canceled)

32. The method as claimed in claim 27, wherein a second spray module is provided, the second spray module is of an identical design to the first spray module, and the first spray module and the second spray module are connected to one another via a first conduit for a fluid in order to obtain a first fire fighting line, wherein, a third spray module and a fourth spray module are provided, the third spray module and the fourth module are of identical design to the first spray module, the third spray module and the fourth spray module are connected to one another via a second conduit for a fluid in order to obtain a second fire fighting line, wherein the second fire fighting line is arranged parallel to the first fire fighting line and at a different height from an underlying surface.
